(19) United States
(12) Patent Application Publication
(10) Pub. No.: US 2010/0023358 A1
(43) Pub. Date: Jan. 28, 2010

(54) RISK ANALYSIS AND MITIGATION SYSTEMS AND METHODS OF ANALYZING AND MITIGATING RISK

(75) Inventors: James T. Fox, Oro Valley, AZ (US); Christopher A. Connor, Oro Valley, AZ (US)

Correspondence Address: RISSMAN HENDRICKS & OLIVERIO, LLP, 100 Cambridge Street, Suite 2101, BOSTON, MA, 02114, US

(73) Assignee: Polaris Aero, LLC, Oro Valley, AZ (US)

(21) Appl. No.: 12/177,509

(22) Filed: Jul. 22, 2008

(51) Int. Cl. G06Q 10/00

(52) U.S. Cl. 705/7; 705/1

(57) ABSTRACT

A machine-implemented method for analyzing risk associated with an activity may include receiving inputs identifying a user and an activity to be analyzed, selecting a boundary dataset including operator data, vehicle/equipment data, and/or general operations data, selecting a boundary parameter from the selected dataset, selecting an environmental parameter associated with the selected boundary parameter, and determining whether the selected environmental parameter exceeds a threshold level of risk associated with the selected boundary parameter.

### TECHNICAL FIELD

The present invention is directed generally to risk analysis and mitigation systems and methods of analyzing and mitigating risk. More particularly, the present invention is directed to methods and systems for detecting, assessing, and controlling risk associated with an activity such as, for example, operation of equipment or vehicles.

### BACKGROUND

It may be desirable to provide methods and systems for analyzing and mitigating risk associated with various activities, such as operation of a vehicle or equipment. The methods and systems may evaluate operator and vehicle/equipment parameters in association with environmental data. It may be desirable to provide a risk profile that identifies parameters of the activity that exceed or are near to exceeding an acceptable risk parameter.

### SUMMARY OF THE INVENTION

According to various aspects of the disclosure, a machine-implemented method for analyzing risk associated with an activity may comprise receiving inputs identifying a user and an activity to be analyzed, selecting a boundary dataset including operator data, vehicle/equipment data, and/or general operations data, selecting a boundary parameter from the selected dataset, selecting an environmental parameter associated with the selected boundary parameter, and determining whether the selected environmental parameter exceeds a threshold level of risk associated with the selected boundary parameter.

In accordance with some aspects of the disclosure, a processing device may comprise at least one processor, a memory, and a bus. The memory may include instructions for the processor, and the bus may provide communication between the processor and the memory. The processor may be configured to process instructions for receiving inputs identifying a user and an activity to be analyzed, selecting a boundary dataset including operator data, vehicle/equipment data, and/or general operations data, selecting a boundary parameter from the selected dataset, selecting an environmental parameter associated with the selected boundary parameter, and determining whether the selected environmental parameter exceeds a threshold level of risk associated with the selected boundary parameter.

According to some aspects of the disclosure, a tangible, machine-readable medium may include instructions for at least one processor recorded thereon. The medium may comprise instructions for receiving inputs identifying a user and an activity to be analyzed, instructions for selecting a boundary dataset including operator data, vehicle/equipment data, and/or general operations data, instructions for selecting a boundary parameter from the selected dataset, instructions for selecting an environmental parameter associated with the selected boundary parameter, and instructions for determining whether the selected environmental parameter exceeds a threshold level of risk associated with the selected boundary parameter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a block diagram of a computer system having an exemplary risk engine in accordance with a possible embodiment of the invention;

FIG. 2 illustrates a block diagram of an exemplary risk analysis and mitigation system in accordance with a possible embodiment of the invention;

FIG. 3 is an exemplary flowchart illustrating an exemplary user process associated with an exemplary risk analysis and mitigation system in accordance with a possible embodiment of the invention; and

FIG. 4 is an exemplary flowchart illustrating an exemplary risk analysis and mitigation process in accordance with a possible embodiment of the invention.

### DETAILED DESCRIPTION

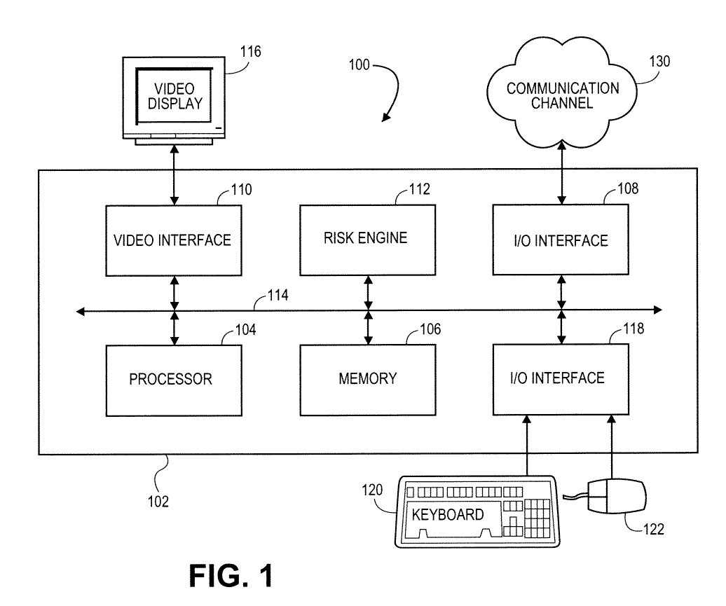

FIG. 1 illustrates a block diagram of an exemplary computer system 100 having a risk engine 112 in accordance with a possible embodiment of the invention. Various embodiments of the disclosure may be implemented using a processing device 102, such as, for example, a general-purpose computer, as shown in FIG. 1.

The computer system 100 may include the processing device 102, an output device 116, and input devices 120, 122. According to some aspects, the output device 116 may comprise a display. In addition, the computer system 100 can have any of a number of other output devices including line printers, laser printers, plotters, and other reproduction devices connected to the processing device 102. The computer system 100 can be connected to one or more other computers via a communication interface 108 using an appropriate communication channel 130 such as, for example, a computer network, a modem communications path, or the like. The computer network may include a wide area network (WAN), a local area network (LAN), an Intranet, and/or the Internet.

The processing device 102 may comprise a processor 104, a memory 106, input/output interfaces 108, 118, a video interface 110, the risk engine 112, and a bus 114. The risk engine 112 refers generally to a module of instructions and may reside on the processor 104 and/or the memory 106, or the risk engine 112 may reside on a physical structure separate from the memory 106 and processor 104. Bus 114 may permit communication among the components of the processing device 102. Processor 104 may comprise one or more physical devices that collectively process instructions, data, or the like and operate in parallel or serially or in any other known manner.

Processor 104 may include at least one conventional processor or microprocessor that interprets and executes instructions. Memory 106 may be a random access memory (RAM) or another type of dynamic storage device that stores information and instructions for execution by processor 104. Memory 106 may also include a read-only memory (ROM) which may include a conventional ROM device or another type of static storage device that stores static information and instructions for processor 104. Memory 106 may include one or more physical structures that collectively provide data storage.

The video interface 110 is connected to the display 116 and provides video signals from the processing device 102 for display on the display 116. User input to operate the processing device 102 can be provided by one or more input devices 120, 122 via the input/output interface 118. For example, an operator can use the keyboard 120 and/or a pointing device such as the mouse 122 to provide input to the processing device 102.

The computer system 100 and processing device 102 may perform such functions in response to processor 104 by executing sequences of instructions contained in a tangible, computer-readable medium, such as, for example, memory 106. Such instructions may be read into memory 106 from another tangible, computer-readable medium, such as a storage device or from a separate device via communication interface 108.

The computer system 100 and processing device 102 illustrated in FIG. 1 and the related discussion are intended to provide a brief, general description of a suitable computing environment in which the invention may be implemented. Although not required, the invention will be described, at least in part, in the general context of computer-executable instructions, such as program modules, being executed by the computer system 100 and processing device 102. Generally, program modules include routine programs, objects, components, data structures, etc. that perform particular tasks or implement particular abstract data types. Moreover, those skilled in the art will appreciate that other embodiments of the invention may be practiced in computer environments with many types of communication equipment and computer system configurations, including cellular devices, mobile communication devices, personal computers, hand-held devices, multi-processor systems, microprocessor-based or programmable consumer electronics, and the like.

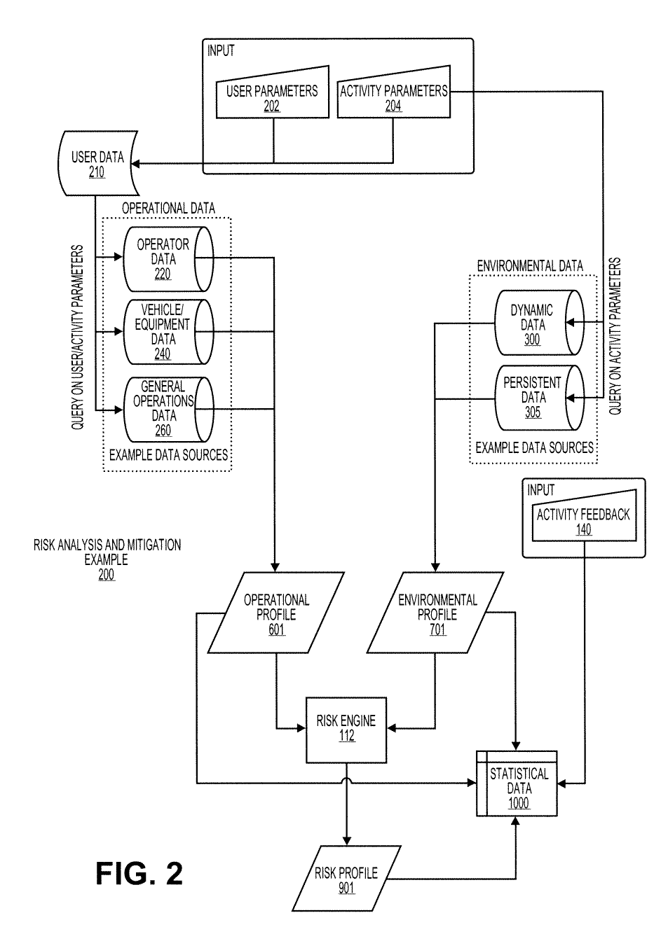

Referring now to FIG. 2, the block diagram illustrates an exemplary risk analysis and mitigation system 200 including the risk engine 112. The risk engine 112 may include instructions for analyzing and mitigating risk associated with an activity. Inputs of the system 200 may include one or more user parameters 202 and/or one or more activity parameters 204. According to some aspects, the user may be the operator associated with the activity to be performed. The user and activity parameters 202, 204 can be input by a user of the system 200 or could be collected by the system 200 automatically. In either event, a combination of the user and activity parameters 202, 204 may be referred to as user data 210. The system 200 may use activity parameters 204 to define an activity to be evaluated by the risk engine 112. According to some aspects, the parameters may include information identifying a vehicle or equipment, an operator, a location, and/or a time.

The system 200 may contain operational boundaries that have been defined for various types of activities. The operational boundaries may be stored in one or more data sources, or databases, in memory 106. For example, according to various embodiments, the data sources may include operator data 220, vehicle or equipment data 240, and general operations data 260.

According to some embodiments, operator data 220 may include information about the operator, such as, for example, qualifications, experience level, certifications, and the like. The system 200 may be configured to store previously-inputted user information so that for future uses, the user can enter a personal identifier which will then permit the system to retrieve stored operator data 220 associated with the user.

In accordance with various exemplary embodiments, vehicle or equipment data 240 may include information pertaining to a vehicle to be operated by the operator. In some embodiments, data pertaining to other types of equipment, such as, for example, oil drilling, medical devices, power generation, and the like, to be operated by the operator may be stored as data 240.

In some exemplary embodiments, for example, where the system 200 comprises a flight risk analysis and mitigation system, the vehicle data 240 may pertain to an aircraft. In such embodiments, the vehicle data 240 may be retrieved, for example, based on the make, model, type or tail number of the aircraft. According to various aspects, the vehicle data 240 may be customized for each aircraft and may include rules based on the aircraft manual retrieved based on the model or type of aircraft. For example, the vehicle data 240 may include information such as, for example, minimum runway required, deicing procedures, maximum/minimum operating temperatures, performance data, and the like.

With regard to the user inputs, the tail number can be retrieved as a default aircraft based on inputted operator data or user identifier. If the user identifier or operator data is associated with multiple aircraft, the user may be prompted to select the appropriate aircraft for the risk assessment. Of course, the user may change the default aircraft to another aircraft when appropriate. For aircraft that require an additional pilot(s), the system 200 may prompt the user to enter information about the additional pilot(s), if applicable.

General operations data 260 may include boundaries that apply to the activity to be analyzed as a whole. General operations data 260 is typically independent of operator data and vehicle data. For example, flying any aircraft is an activity governed by federal rules and regulations. In general, these rules and regulations apply to everyone and every aircraft. However, some rules only apply to certain activities (depending on whether the activity to be analyzed is a charter flight, a scheduled flight, etc). Other examples of general operations data 260 include owner/operator defined limits, company operating procedures, international rules and procedures (e.g. ICAO), and the like. In other exemplary embodiments where the disclosed system 200 may be implemented to analyze risk pertaining to operation of an automobile or other type of ground transportation, the general operations data 260 may include state traffic laws, for example.

The system 200 applies the inputted user parameters 202 and/or the activity parameters 204 to create a unique subset of operational boundaries, which apply to the specific activity being evaluated. To create the unique subset, the system 200 creates a query for each data source 220, 240, 260 based on the user and/or activity parameters 202, 204 inputted. For example, if the input specifies a particular operator and a particular vehicle, the system 200 uses those parameters to query each data source, operator data 220 and vehicle data 240 respectively, for pertinent operational boundaries. For activities having general boundaries that apply to the operation as a whole, such as, for example, flying an aircraft, general operations data 260 is another data source queried by the system 200. It should be appreciated that the number of data sources queried depends on the particular activity being evaluated.

The results of the data source queries carried out by the system 200 may be stored in a result data set called an operational profile 601. The operational profile 601 contains the aggregate of operational boundaries that define the limits of safe operation (i.e. safety envelope) for the activity to be analyzed for risk.

The system 200 carries out a similar process to develop an environmental profile 701 for the activity being analyzed for risk. The system 200 may include environmental boundaries for the activity. The environmental boundaries may be stored in one or more data sources, or databases, in memory 106. For example, according to various embodiments, the environmental data sources may include dynamic data 300 and/or persistent data 305.

According to some embodiments pertaining to risk analysis in a flight scenario, persistent data 305 may include information about the takeoff and landing facilities such as, for example, location, runways (e.g., number, orientation, and length), lights, and the like. Such airport parameters are updated approximately every 2 months and may include 200-300 pieces of data per facility. Dynamic data 300 may include, for example, weather information, Notices to Airmen (NOTAMS), airport delays, and the like. According to various aspects, the system 200 may be configured to retrieve weather information from NOAA and/or changes to facilities, procedures, airspace, and/or equipment from NOTAMS.

Thus, the environmental profile 701 contains information describing the environment in which the activity will take place. For example, if the input parameters specify a time and a location, the system would use those parameters to query dynamic and persistent environmental data sources 300, 305 for the necessary information. The system queries the appropriate data source for each input parameter. The results of the queries are aggregated into the environmental profile 701.

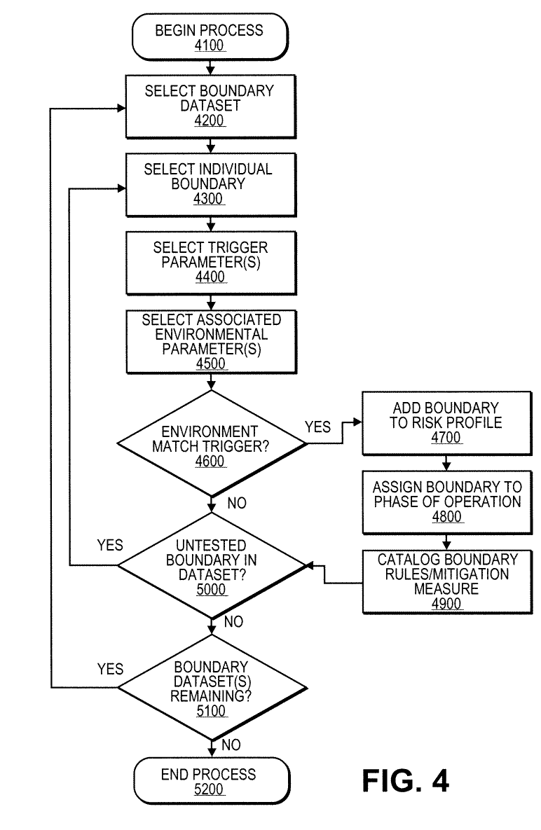

The system 200 includes the risk engine 112, which is configured to aggregate the operational profile 601 and the environmental profile 701 and to determine the likelihood of exceeding any operational boundary contained in the operational profile. The process employed by the risk engine is described in more detail below in reference to FIG. 4. Any operational boundary that may be exceeded is added to a dataset called the risk profile 901, which is the output of the system 200. The risk profile 901 identifies all operational boundaries that may be exceeded during the activity being analyzed. The risk profile 901 may include mitigation information to help the user ensure the activity remains within the safety envelope.

The system 200 may also accept feedback from the user in order to improve the system over time. The feedback may be stored in a dataset 1000, for example, in memory 106, and correlated with the operational profile, environmental profile, and risk profile for a particular activity. Analysis of the feedback could result in modification of operational boundaries, development of additional environmental parameters, and/or refashioning of the user interface.

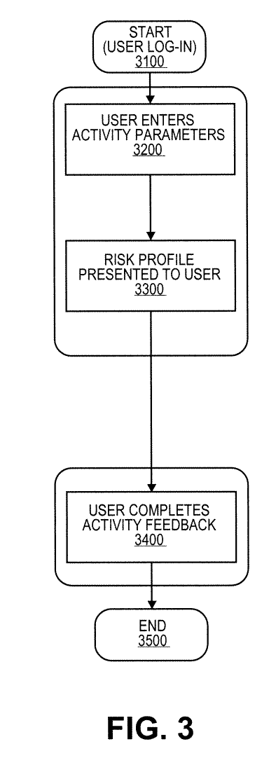

Referring now to FIG. 3, an exemplary user process associated with an exemplary risk analysis and mitigation system is shown. The user process begins at step 3100 where the system 200 receives information inputted by a user. The system 200 may use this information to identify the user and can customize the user process based on any specific user requirements. The system can also be configured to provide generic assessments regardless of user specifics. Control continues to step 3200.

In step 3200, the system 200 receives parameters that define the activity to be assessed. The parameters could be manually input by a user or the system could retrieve them automatically via a database query, web services, integration with third party software, or the like. The parameters may include specific information on various aspects of the activity such as, for example, operator, equipment, vehicle, location, and time. Control continues to step 3300.

Then, in step 3300, the system 200 evaluates the activity by way of the risk engine 112 and presents the user with a risk profile 901. The risk profile 901 identifies operational boundaries that are or are near to being exceeded. The threshold at which the system 200 includes a boundary in the risk profile may be modified as desired by the system operator. In addition, the risk profile may contain mitigation measures to help the user comply with all operational boundaries and ensure the activity remains within the safety envelope. Control continues to step 3400.

Next, in step 3400, the system 200 receives feedback 140 from the user when appropriate. The feedback information may be used to improve the system 200.

For illustrative purposes, an exemplary risk engine 112 will be described below in relation to the block diagrams shown in FIGS. 1 and 2 and the exemplary user process shown in FIG. 3.

FIG. 4 is a flowchart illustrating some of the basic steps associated with an exemplary risk analysis and mitigation process in accordance with a possible embodiment of the invention. The process may be carried out by the risk engine 112. The process begins at step 4100 and continues to step 4200.

In step 4200, the risk engine 112 selects a boundary dataset from the operational profile 601. The operational profile 601 may contain any number of boundary datasets depending on the number of sources 220, 240, 260 that were queried. For example, one boundary dataset based on operator data 220 may have information pertaining to an operator, while another dataset based on vehicle data 240 may contain operational boundaries for a vehicle or equipment. The risk engine 112 may analyze datasets sequentially. However, according to some aspects of the disclosure, multiple risk engines can be employed in parallel to simultaneously analyze all boundary datasets. Control continues to step 4300.

Next, in step 4300, the risk engine 112 selects an individual boundary from the current boundary dataset. Each boundary may include three components: a trigger, a rule, and a mitigation measure. The “trigger” contains the parameters defining in which environmental conditions the boundary applies. The “rule” describes the limitation imposed by the boundary. The “mitigation measure” contains procedures or advisories designed to reduce the risk of exceeding an operational limitation. For example, FAA regulations may state that pilots must designate an alternate airport on the flight plan if the cloud ceiling is less than 2000 feet above the ground at the destination airport. This operational boundary may be split into its three components as follows: The rule—a pilot must designate an alternate airport. The trigger—the cloud ceiling at destination airport is less than 2000 feet above the ground. The mitigation measure—recommend an appropriate alternate airport. Control continues to step 4400 where the risk engine 112 selects one or more trigger parameters. Control continues to step 4500.

Then, in step 4500, the risk engine 112 queries the environmental profile 701 for the environmental parameters associated with parameters listed in the previously-selected boundary trigger(s). Control continues to step 4600 where the risk engine compares the environmental parameters from the environmental profile 701 with the parameters of the boundary trigger. If the conditions of the trigger are met, the control continues to step 4700. If the conditions of the trigger are not met, control skips to step 5000.

In step 4700, when the conditions of the trigger are met, as determined in step 4600, the risk engine 112 adds that boundary to the risk profile. Control then continues to step 4800 where the risk engine 112 assigns the boundary to a phase of operation. The risk profile 901 is categorized by phase of operation. For example, the phases of operation may include, but are not limited to, ground operations before takeoff, taxi before takeoff, takeoff, departure, en-route, approach, landing, taxi after landing, and ground operations after landing. This categorization allows the user to easily identify operational areas that may be outside the safety envelope. Control proceeds to step 4900.

Next, in step 4900, the risk engine 112 catalogues the boundary rules and mitigation measures to the appropriate phase of operation within the risk profile. Control then continues to step 5000 where the risk engine 112 determines if there are any untested boundaries remaining in the current boundary dataset. If boundaries remain in the dataset, the control returns to step 4300 and the next boundary in the dataset is selected. Otherwise, if no boundaries remain in the dataset, control proceeds to step 5100.

In step 5100, the risk engine 112 determines whether there are any boundary datasets remaining in the operational profile 601. If there are datasets remaining in the operational profile 601, control returns to step 4200 and the next boundary dataset is selected. Otherwise, if no boundary datasets remain, control continues to step 5200 and the risk engine process ends.

Embodiments within the scope of the present disclosure may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

It will be apparent to those skilled in the art that various modifications and variations can be made in the systems and methods of the present disclosure without departing from the scope of the invention. Other embodiments of the invention will be apparent to those skilled in the art from consideration of the specification and practice of the invention disclosed herein. It is intended that the specification and examples be considered as exemplary only.

What is claimed is:

1. A machine-implemented method for analyzing risk associated with an activity, the method comprising:
receiving inputs identifying a user and an activity to be analyzed;
selecting a boundary dataset including at least one of operator data, vehicle/equipment data, and general operations data;
selecting a boundary parameter from said selected dataset;
selecting an environmental parameter associated with said selected boundary parameter; and
determining whether said selected environmental parameter exceeds a threshold level of risk associated with said selected boundary parameter.

2. The method of claim 1, further comprising outputting a risk profile that identifies environmental parameters that exceed a threshold level of risk associated with boundary parameters.

3. The method of claim 1, wherein the selected boundary dataset includes operator data, and the operator data includes at least one of qualifications, experience level, and certifications.

4. The method of claim 1, wherein the selected boundary dataset includes vehicle/equipment data, and the vehicle/equipment data includes information pertaining to one of a vehicle and/or equipment to be operated by an operator.

5. The method of claim 1, wherein the selected boundary dataset includes general operations data, and the general operations data includes at least one of federal rules and regulations, state laws, owner/operator defined limits, company operating procedures, and international rules and procedures.

6. The method of claim 1, wherein the selected environmental parameter is one of dynamic data and persistent data.

7. A processing device comprising:
at least one processor;
a memory including instructions for the processor; and
a bus for providing communication between the processor and the memory, the processor being configured to process instructions for
receiving inputs identifying a user and an activity to be analyzed,
selecting a boundary dataset including at least one of operator data, vehicle/equipment data, and general operations data,
selecting a boundary parameter from said selected dataset,
selecting an environmental parameter associated with said selected boundary parameter, and
determining whether said selected environmental parameter exceeds a threshold level of risk associated with said selected boundary parameter.

8. The device of claim 7, further comprising an output device configured to output a risk profile that identifies environmental parameters that exceed a threshold level of risk associated with boundary parameters

9. The device of claim 7, wherein the selected boundary dataset includes operator data, and the operator data includes at least one of qualifications, experience level, and certifications.

10. The device of claim 7, wherein the selected boundary dataset includes vehicle/equipment data, and the vehicle/equipment data includes information pertaining to one of a vehicle and/or equipment to be operated by an operator.

11. The device of claim 7, wherein the selected boundary dataset includes general operations data, and the general operations data includes at least one of federal rules and regulations, state laws, owner/operator defined limits, company operating procedures, and international rules and procedures.

12. The device of claim 7, wherein the selected environmental parameter is one of dynamic data and persistent data.

13. A tangible, machine-readable medium having instructions for at least one processor recorded thereon, the medium comprising:
instructions for receiving inputs identifying a user and an activity to be analyzed;
instructions for selecting a boundary dataset including at least one of operator data, vehicle data, and general operations data;
instructions for selecting a boundary parameter from said selected dataset;
instructions for selecting an environmental parameter associated with said selected boundary parameter; and
instructions for determining whether said selected environmental parameter exceeds a threshold level of risk associated with said selected boundary parameter.

14. The medium of claim 1, further comprising instructions for outputting a risk profile that identifies environmental parameters that exceed a threshold level of risk associated with boundary parameters

15. The medium of claim 1, wherein the selected boundary dataset includes operator data, and the operator data includes at least one of qualifications, experience level, and certifications.

16. The medium of claim 1, wherein the selected boundary dataset includes vehicle/equipment data, and the vehicle/equipment data includes information pertaining to one of a vehicle and/or equipment to be operated by an operator.

17. The medium of claim 1, wherein the selected boundary dataset includes general operations data, and the general operations data includes at least one of federal rules and regulations, state laws, owner/operator defined limits, company operating procedures, and international rules and procedures.

18. The medium of claim 1, wherein the selected environmental parameter is one of dynamic data and persistent data.
